(19) United States
(12) Patent Application Publication
(10) Pub. No.: US 2023/0235138 A1
(43) Pub. Date: Jul. 27, 2023

(54) LAYER INCLUDING CALCIUM CARBONATE

(71) Applicant: Okeanos Group, LLC, Miami Beach, FL (US)

(72) Inventors: Russell Petrie, Irvine, CA (US); William Belias, Pittsford, NY (US)

(21) Appl. No.: 18/157,666

(22) Filed: Jan. 20, 2023

Related U.S. Application Data
(60) Provisional application No. 63/267,021, filed on Jan. 21, 2022.

(51) Int. Cl. C08J 5/18; C08L 29/04; C08K 3/26; C08K 9/04; C08J 7/04

(52) U.S. Cl. CPC C08J 5/18; C08L 29/04; C08K 3/26; C08K 9/04; C08J 7/04; C08J 2329/04; C08J 2389/00; C08K 2003/265

(57) ABSTRACT

A layer includes polyvinyl alcohol and 20 wt % or more calcium carbonate, based on the total weight of the layer. Another layer includes polyvinyl alcohol and calcium carbonate. A container includes a body that defines an internal cavity capable of holding an article, the body including a layer including polyvinyl alcohol and 20 wt % or more of calcium carbonate, based on the total weight of the layer. Another container includes a layer including polyvinyl alcohol and calcium carbonate.

### CROSS-REFERENCE TO RELATED APPLICATION(S)

The present application claims priority to and the benefit of U.S. Provisional Application No. 63/267,021, filed in the United States Patent and Trademark Office on Jan. 21, 2022, the entire content of which is incorporated herein by reference.

### BACKGROUND

Layers including calcium carbonate may be used in a variety of applications. For example, such layers may be used to form containers, paper, paper products, and the like. The layers include calcium carbonate, a polymer (e.g., polyethylene or other petroleum-based polymers), and, optionally, one or more additional components. Petroleum-based polymers such as polyethylene, however, have limited degradation properties (e.g., are not dissolvable in water) and rely on certain compostable conditions and/or additives to accelerate degradation. Further, such layers include calcium carbonate at relatively low loading levels.

### SUMMARY

Embodiments of the present disclosure are directed to a layer including polyvinyl alcohol and calcium carbonate at relatively high loading levels. For example, embodiments of the layer include polyvinyl alcohol and 20 wt % or more of calcium carbonate, based on the total weight of the layer. Embodiments of the disclosure are also directed to a layer including polyvinyl alcohol and calcium carbonate in any suitable amount.

### DETAILED DESCRIPTION

In the following detailed description, only certain embodiments of the subject matter of the present disclosure are described, by way of illustration. As those skilled in the art would recognize, the subject matter of the present disclosure may be embodied in many different forms and should not be construed as being limited to the embodiments set forth herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described.

Embodiments of the present disclosure are directed toward a layer including polyvinyl alcohol and calcium carbonate (CaCO₃). For example, embodiments of the layer include calcium carbonate at relatively high loading levels (e.g., at amounts of 20 weight percent (wt %) or more, 20 wt % or more, or 25 wt % or more, based on the total weight of the layer). In one or more embodiments, the calcium carbonate may be included in the layer at an amount of 20 wt % to 97 wt %, 25 wt % to 97 wt %, 35 wt % to 97 wt %, 49 wt % to 97 wt %, 35 wt % to 90 wt %, 49 wt % to 90 wt %, 50 wt % to 97 wt %, 50 wt % to 90 wt %, 51 wt % to 97 wt %, 51 wt % to 90 wt %, 54.5 wt % to 97 wt %, 54.5 wt % to 90 wt %, 55 wt % to 97 wt %, 55 wt % to 90 wt %, 60 wt % to 97 wt %, 60 wt % to 90 wt %, 61 wt % to 97 wt %, 61 wt % to 97 wt %, 65 wt % to 97 wt %, 65 wt % to 90 wt %, 70 wt % to 97 wt %, 70 wt % to 90 wt %, 71 wt % to 97 wt %, 71 wt % to 90 wt %, 75 wt % to 97 wt %, 75 wt % to 90 wt %, 80 wt % to 97 wt %, 80 to wt % to 90 wt %, 81 wt % to 97 wt %, 81 wt % to 90 wt %, or any range subsumed therein, based on the total weight of the layer.

Embodiments of the layer including polyvinyl alcohol and calcium carbonate may be used to form a mulching film, a pesticide container, a bale film, a bale net, an expanded polystyrene box substitute, an irrigation drip tape, a fishing net, a fishing rope, a cage, a plastic bag, a net float, a fertilizer container, a plant pot, a seedling plug, a plastic tie, a rope, twine, a bag for feed, bale twine, a greenhouse film, a tree guard, a pond liner, an irrigation tube, an irrigation drip, an ear tag, or a crate for harvesting. The layer including polyvinyl alcohol and calcium carbonate may be used in any suitable manner for plants (e.g., crops, fruits, trees, and the like) and/or any suitable activities associated with the plants, and/or the layer including polyvinyl alcohol and calcium carbonate may be used in any suitable manner for animals (e.g., livestock and the like) and/or any suitable activities associated with the animals.

In some embodiments, the layer including polyvinyl alcohol and calcium carbonate may be used in the agricultural industry as a film, sheet, or layer to protect and/or warm plants (e.g., by trapping heat from the sun and/or ambient atmosphere). For example, embodiments of the layer including polyvinyl alcohol and calcium carbonate may be placed over the plants to form a housing for the plants (e.g., a polytunnel, a polyhouse, a hoop house, a hoop green house, a grow tunnel, a high tunnel, or a greenhouse), and/or the respective plants may protrude through apertures (e.g., openings) in a layer including polyvinyl alcohol and calcium carbonate contacting soil that the plants are growing in so that the layer including polyvinyl alcohol and calcium carbonate warms the soil and prevents or reduces growth of weeds adjacent to the plants.

Utilizing embodiments of the layer including polyvinyl alcohol and calcium carbonate in the agricultural industry reduces the contribution of the agricultural industry to plastic pollution and may provide additional benefits. For example, because the layer including polyvinyl alcohol and calcium carbonate includes calcium carbonate, the layer including polyvinyl alcohol and calcium carbonate may stabilize or improve the pH of the soil as the layer including polyvinyl alcohol and calcium carbonate decomposes and adds calcium carbonate to the soil. In some embodiments, as the layer including polyvinyl alcohol and calcium carbonate decomposes, calcium carbonate is added to the soil from the layer including polyvinyl alcohol and calcium carbonate, thereby raising the pH of the soil.

The layer including polyvinyl alcohol and calcium carbonate may be configured to decompose over a set or predetermined time that may coincide with times for pH adjustment of the soil. For example, the decomposition of the layer including polyvinyl alcohol and calcium carbonate and the addition of calcium carbonate to the soil may be configured to correspond with the biological profile of the plants that are being protected and/or warmed by the layer including polyvinyl alcohol and calcium carbonate. In some embodiments, the layer including polyvinyl alcohol and calcium carbonate may be configured to release calcium carbonate into the soil during a set or predetermined time to control the pH of the soil. In some embodiments, the concentration of the calcium carbonate and/or polyvinyl alcohol may be adjusted, and/or a decomposition additive may be included in the layer including polyvinyl alcohol and calcium carbonate, so that the layer including polyvinyl alcohol and calcium carbonate releases the calcium carbonate during the set or predetermined time. In some embodiments, the layer including polyvinyl alcohol and calcium carbonate may be plowed into the soil so that the layer including polyvinyl alcohol and calcium carbonate decomposes and releases calcium carbonate into the soil after having been plowed into the soil. In some embodiments the layer including polyvinyl alcohol and calcium carbonate balances the pH of acidic soils based on a degradation rate of the layer including polyvinyl alcohol and calcium carbonate, thereby harmonizing the pH of the soil with the pH profile or needs of the plants (e.g., crops, fruits, trees, and the like) to maximize or increase agricultural yield and growth performance.

Embodiments of the layer including polyvinyl alcohol and calcium carbonate may be formed as a mono-material to enhance recyclability and/or reuse, for example, when used as a silage film. In some embodiments, the layer including polyvinyl alcohol and calcium carbonate may include a plurality of layers that are the same as or different from each other. The plurality of layers may have degradation rates that are the same as or different from each other. In some embodiments, one or more of the plurality of layers may include an additive (e.g., a degradant), and/or one or more of the plurality of layers may be free or substantially free of an additive (e.g., a degradant). As used herein, the term “substantially free” means that the cited component is not present, or, if present, is only present as an incidental impurity.

The additive may be any suitable additive generally used in the art that accelerates degradation of a polymer. In some embodiments, the additive may include an oxo-degradable additive (e.g., an oxo-biodegradable additive), but the present disclosure is not limited thereto, and the additive may be include any suitable additive generally used in the art that accelerates degradation of a polymer. For example, the additive may not include, and may be completely free of, oxo-degradable additives and oxo-biodegradable additives. In some embodiments, the layer including polyvinyl alcohol and calcium carbonate is completely free of oxo-degradable additive and oxo-biodegradable additives. The layer including polyvinyl alcohol and calcium carbonate may include that the additive in an amount of 0.01 wt % to 20 wt % (or 0.01 wt % to 10 wt %), based on the total weight of the layer including polyvinyl alcohol and calcium carbonate. The additive (e.g., the oxo-degradable additive) may increase the rate at which the polymer oxo-degrades when exposed to oxygen. For example, the oxo-degradable additive may increase the rate at which the polymer is oxidized. The polymer may breakdown when exposed to oxygen without the need for bacteria microbes to initially break down the polymer. After (or concurrently or simultaneously with) the oxidation of the polymer, organisms (e.g., microbes, bacteria and/or the like) may further degrade the remaining portions of the polymer. This process may be referred to as oxo-biodegradation. Thus, the oxo-degradable additive causes the polymer to oxo-biodegrade.

The additive may include any suitable additive that increases the rate at which the polymer is oxidized or oxo-biodegraded. The additive may include any non-heavy metal additive or salt that complies with European Union Packaging Waste Directive 94/62, Article 11 and similar U.S. laws and/or regulations. In some embodiments, the oxo-degradable additive includes a salt such as, for example, an iron salt, a manganese salt, a cobalt salt, and/or any suitable non-heavy metal salt, but the present disclosure is not limited thereto. As used herein, the term “heavy metal” may refer to those elements that are restricted under European Union Packaging Waste Directive 94/62, Article 11. Non-limiting, non-heavy metal, commercially available examples of the oxo-degradable additive include those available from Willow Ridge Plastics Inc. (Erlanger, Ky.) and/or Bio-Tec Environmental, LLC (Cedar Crest, N. Mex.).

In some embodiments, a concentration of the additive may vary along a concentration gradient from one side to another side of the layer including polyvinyl alcohol and calcium carbonate. For example, one side of the layer including polyvinyl alcohol and calcium carbonate may be exposed to direct ultraviolet (UV) light (e.g., from the sun), which catalyzes breakdown of the layer including polyvinyl alcohol and calcium carbonate resulting in an increased degradation rate relative to a side that is not directly exposed the UV light. Accordingly, in some embodiments, the side that is not directly exposed to the UV light may have a relatively higher concentration of the additive (e.g., the degradant) while the side exposed to the UV light may have a relatively lower concentration of the additive (e.g., the degradant), or may be free or substantially free of the additive to thereby more closely match a degradation rate of the side directly exposed to the UV light with the degradation rate of the side that is not exposed to the UV light. In some embodiments, the concentration of the additive may decrease along a concentration gradient from the side not directly exposed to the UV light to the side directly exposed to the UV light.

Any suitable calcium carbonate may be used in embodiments of the disclosure. The calcium carbonate may be treated (e.g., treated with stearic acid) or untreated. For example, treating the calcium carbonate with stearic acid allows for higher concentrations of calcium carbonate to be used. As such, according to embodiments of the present disclosure, the calcium carbonate may be treated with stearic acid prior to, or during, formation of the layer to form stearic acid treated calcium carbonate (e.g., a reaction product of calcium carbonate and stearic acid). The calcium carbonate may be used together with an additive that acts as a lubricant that allows for an increase the amount of calcium carbonate (e.g., in an amount of greater than 20 wt %, 25 wt %, or 35 wt %). The calcium carbonate may be dried prior to formation of the layer. For example, prior to forming the layer, the calcium carbonate may be dried to less than 300 ppm of moisture. Non-limiting, commercially available embodiments of the calcium carbonate include Omyacarb OM3 (obtained from Omya, Switzerland).

According to embodiments of the present disclosure, the layer includes polyvinyl alcohol and calcium carbonate, which can be easily separated by way of dissolution and/or hydrolysis, thereby making components of the layer easy to recycle. Without limiting the present disclosure to any particular mechanism, the present inventors recognized that calcium carbonate can easily be separated from a layer including polyvinyl alcohol and calcium carbonate by way of dissolution and/or hydrolysis, a feature not previously recognized as recycling is not thought to be a likely end of life scenario for polyvinyl alcohol and calcium carbonate, as polyvinyl alcohol at level greater than or equal to 5 wt % are not favored in current recycling.

Calcium carbonate can be recycled if it is coupled with polyvinyl alcohol, which may provide significant environmental advantages by, for example, lowering the carbon (CO₂) footprint of the product including the polyvinyl alcohol and calcium carbonate. Recycling calcium carbonate from a polymer layer including calcium carbonate is novel, as calcium carbonate is difficult to separate from existing layers including calcium carbonate and polyolefin polymers. Thus, embodiments of the present disclosure provide the novel feature of recyclability of a layer by separating calcium carbonate from polyvinyl alcohol by way of, for example, dissolution and/or hydrolysis.

Unlike polymers (with the exception of polyethylene terephthalate (PET)), calcium carbonate can be recycled a plurality of times without (or substantially without) changes to the physical properties of the recycled calcium carbonate. By including calcium carbonate at high loading levels, embodiments of the disclosure provide a layer that has exceptional strength (e.g., is suitable for forming rigid products such as, for example, packaging and/or containers) and that includes a component that can be recycled a nearly unlimited number of times. For example, the calcium carbonate of the layer can be separated from the other components of the layer and recycled as many times as the calcium carbonate remains recoverable and/or separable. The polyvinyl alcohol may also be recoverable and/or separable, and thus, may also be recycled.

The separation of the calcium carbonate from the polyvinyl alcohol may be facilitated by a difference in density between the calcium carbonate and the polyvinyl alcohol and/or any other components of the layer. In contrast to the presently disclosed embodiments, polyethylene (or other similar polyolefin polymers) cannot be similarly separated from calcium carbonate, thereby rendering recycling of individual elements (e.g., polyethylene and calcium carbonate) of a layer including polyethylene and calcium carbonate very difficult. For example, the individual elements of polyethylene and calcium carbonate are difficult to individually recycle once they have been combined together. In contrast, polyvinyl alcohol and calcium carbonate can be separated from embodiments of the layer including polyvinyl alcohol and calcium carbonate, thereby providing the ability to individually recycle these components from embodiments of the present disclosure.

In one or more embodiments, the calcium carbonate may be separated from the polyvinyl alcohol of the layer by dissolving the polyvinyl alcohol (e.g., by washing with water, together with or without heating the water) and/or by decomposing the polyvinyl alcohol (e.g., by having bacteria digest the polyvinyl alcohol). Thus, embodiments of the disclosure are suitable for applications where recycling is beneficial such as, for example, products for fast food and/or fast service restaurants, entertainment venues (e.g., sports stadiums), vehicles (e.g., flying vehicles such as, for example, passenger aircraft, and ships such as, for example, cruise ships and naval vessels). For example, according to embodiments of the disclosure, a product including embodiments of the layer may be used on a ship and after use, the calcium carbonate may be separated from the polyvinyl alcohol in any suitable manner, the calcium carbonate may be deposited in water (e.g., an ocean, lake, river, and/or the like), and the polyvinyl alcohol (and/or decomposition product and/or other byproduct of the polyvinyl alcohol) may be suitably disposed (e.g., may be recycled and/or made into fertilizer).

Embodiments of the present disclosure are also directed to a layer including polyvinyl alcohol (PVOH) and calcium carbonate in any suitable amount. Because a melting point of polyvinyl alcohol is relatively higher than the melting point of, for example, polyethylene, embodiments of the layer including PVOH and calcium carbonate, have relatively high thermolytic stability. For example, embodiments of the layer may be thermally stable in air at temperatures up to at least 200° C.

Unlike polyethylene, polyvinyl alcohol may be hydrolyzed such that the polyvinyl alcohol may be dissolved in water. As such, embodiments of the layer including polyvinyl alcohol and calcium carbonate may be immersed in water to dissolve the polyvinyl alcohol and to separate the calcium carbonate from the polyvinyl alcohol. Thus, embodiments of the layer may include hydrolyzable polyvinyl alcohol to increase the rate at which the layer may be degraded or decomposed when the layer is disposed of, as compared to other products including a petroleum-based polymer such as, for example, polyethylene. After being dissolved in water, the polyvinyl alcohol ultimately decomposes into breakdown products (e.g., carbon dioxide, methane, acetate, and/or water). Acids and/or bases may be used to improve and/or accelerate the hydrolytic breakdown of the polyvinyl alcohol. For example, sodium hydroxide (NaOH) may be used at low concentrations (e.g., pH>9.0) to improve and/or accelerate the hydrolytic breakdown of the polyvinyl alcohol. In some embodiments, NaOH assists with protein breakdown, if protein is present. Additionally, if a metallized layer and/or plasma layer is present, the metallized layer and/or plasma layer would be separated from the other components of the layer.

Cross-linking the polyvinyl alcohol may decrease the rate at which the polyvinyl alcohol hydrolyzes, as compared to uncross-linked polyvinyl alcohol. For example, embodiments of uncross-linked polyvinyl alcohol may dissolve in water at temperatures of 12° C., and embodiments of cross-linked polyvinyl alcohol may be thermally stable in water up to temperatures of 40° C. or 90° C. By having high thermal stability (e.g., thermal stability of up to temperatures of 30° C. or 150° C.), the function of the polyvinyl alcohol may be improved and its uses may be expanded. Cross-linking the polyvinyl alcohol may increase the rigidity of the resultant layer including the cross-linked polyvinyl alcohol. In addition to increasing the rigidity of the resultant layer, cross-linking the polyvinyl alcohol may increase the amount of calcium carbonate that may be included in the resultant layer including the cross-linked polyvinyl alcohol. Cross-linking of the polyvinyl alcohol will also increase the adhesion between calcium carbonate and polyvinyl alcohol which results in higher tensile strength. The polyvinyl alcohol may be cross-linked in any suitable manner, and is not limited to any particular process or cross-linker. For example, the polyvinyl alcohol may be cross-linked through chemical cross-linking by insertion of acid groups, bases (e.g., basic groups), and/or mixtures or combinations thereof. Due to the hydrophilic character of polyvinyl alcohol, free hydroxyl groups of the polyvinyl alcohol can cross-link to a cross-linking agent's functional group. The following cross-linking agents are non-limiting examples of that will cross-link with polyvinyl alcohol and improve thermal stability of the polyvinyl alcohol: sulfonic acid groups and carboxylic acid groups such as, for example, sulfosuccinic acid and citric acid. Additional, non-limiting examples of cross-linking agents include glutaraldehyde, formaldehyde, iron sulfate heptahydrate, hydrogen peroxide, and sodium hydroxide. For example, the polyvinyl alcohol may be cross-linked utilizing citric acid and/or aldehydes as cross-linkers. In one or more embodiments, the cross-links may include oxygen atoms. Including cross-linked polyvinyl alcohol in the layer may also increase the strength and/or rigidity of the layer. Thus, embodiments of the layer may include cross-linked polyvinyl alcohol to increase the water resistance of the layer, to increase the strength of the layer, and/or to increase the rigidity of the layer.

The composition of the polyvinyl alcohol is not particularly limited and any suitable polyvinyl alcohol available in the art may be used. Embodiments of the polyvinyl alcohol may have a high hydroxyl group content and high hygroscopicity. The hydroxyl group content of the polyvinyl alcohol may be in any suitable amount generally used in the art. In some embodiments, the hydroxyl group content is 24 to 47 mol %. The hydroxyl content of the polyvinyl alcohol reflects the number of hydroxyl groups present in the polyvinyl alcohol. The % of hydroxyl groups corresponds to the number of hydroxyl groups present in the polyvinyl alcohol, and thus, a higher % of hydroxyl groups indicates a higher number of hydroxyl groups in the polyvinyl alcohol. As the hydroxyl content of the polyvinyl alcohol increases, the polyvinyl alcohol more easily undergoes hydrolysis and becomes more miscible in water. Additionally, increasing the hydroxyl content of the polyvinyl alcohol increases the number of potential cross-linking sites of the polyvinyl alcohol. Non-limiting, commercially available embodiments of the polyvinyl alcohol include Auqapak Hydropol 30164P (available from Aquapak Polymers Ltd., Birmingham, United Kingdom) and any suitable polyvinyl alcohol available from Kuraray (Chiyoda City, Tokyo, Japan) such as, for example, POVAL™.

Including polyvinyl alcohol in the layer also allows for substantial increases in the amount of calcium carbonate in the layer as compared to layers that include polyethylene. For example, for layers that include polyethylene, the viscosity of a composition for forming the layer increases as the amount of calcium carbonate increases, resulting in a corresponding increase in processing difficulty using existing equipment. For layers that include polyethylene, the processing temperature for the composition for forming the layer increases as the amount of calcium carbonate increases in order to reduce the viscosity of the composition to levels suitable for processing, thereby increasing the energy intensity of the process.

For layers that include polyvinyl alcohol, the viscosity of the composition for forming the layer may be reduced by adding water and/or by adding a viscosity reducing agent such as glycerol, low molecular weight PHA (polyhydroxy alkanoates), PLA (polylactic acid), and/or polyethylene glycol even when the calcium carbonate amount is increased to high levels (e.g., 20 wt % to 97 wt %, 25 wt % to 97 wt %, or 35 wt % to 97 wt %, based on the total weight of the layer), thereby improving the processability of the composition. Thus, embodiments of the layer including polyvinyl alcohol and calcium carbonate may be processed even at high loading levels of calcium carbonate (e.g., 20 wt % to 97 wt %, 25 wt % to 97 wt %, or 35 wt % to 97 wt %, based on the total weight of the layer). According to embodiments of the disclosure, water may be added to a composition for forming a layer including polyvinyl alcohol and calcium carbonate to decrease the viscosity of the composition, and then at least a portion of the water may be subsequently removed and/or an additive such as, for example, starch, gluten, cellulose, and/or an industrial protein may be added to increase the viscosity subsequent to and/or during processing. Embodiments of the layer including polyvinyl alcohol and calcium carbonate may be processed and/or formed using existing compounding and extrusion equipment used for processing polyethylene resins. In one or more embodiments, the polyvinyl alcohol may be handled, stored, and/or processed in any suitable manner to avoid or reduce moisture absorption such as, for example, as handling, storing, and/or processing together with suitable desiccants and/or under a nitrogen atmosphere.

Embodiments of the layer including polyvinyl alcohol and calcium carbonate may exhibit synergistic effects as a result of the combination of polyvinyl alcohol and calcium carbonate. For example, while a layer including relatively pure polyvinyl alcohol may exhibit a substantial decrease in strength after 5 months, a layer including polyvinyl alcohol and 50 wt % calcium carbonate, based on the total weight of the layer, exhibited substantially the same strength (e.g., tensile strength in MPa or psi) after 5 months. Stress/strain data for examples of embodiments of the present disclosure and comparative examples are shown below.

| | Aquapak + | | Kuraray + | | |
|---|---|---|---|---|---|
| | 55% Treated | Aquapak + | 55% treated | | Poly- |
| | CaCO₃ + | 55% Treated | CaCO₃ + | Aquapak | propylene |
| | additives | CaCO₃+ | additives | 100% | 100% |
| *Sec. | 236,444 | 292,868 | 257,692 | 217,963 | 153,540 |
| Mod. | | | | | |
| psi | | | | | |
| *Sec. | 1630 | 2019 | 1777 | 1503 | 1058 |
| Mod. | | | | | |
| MPa | | | | | |

*Sec. Mod. = Secant Modulus
*psi = pounds per square inch
*MPa = mega pascals

As can be seen above, all conditions of the examples are stiffer with the addition of CaCO₃.

As described with respect to the Examples below, the stiffness of non-treated strips including polyvinyl alcohol and 40% CaCO₃ after 8 weeks at ambient conditions was 57% of the initial stiffness, while the stiffness of treated strips including polyvinyl alcohol and 40% CaCO₃ after 8 weeks at ambient conditions was 81% of the initial stiffness. Thus, embodiments of the layer including polyvinyl alcohol and calcium carbonate exhibit unexpected and beneficial property changes. While the present disclosure is not limited by any particular mechanism or theory, it is believed that chemical bonds and/or physical interactions between the polyvinyl alcohol and the calcium carbonate provide unexpected and beneficial increases in strength and/or rigidity. These unexpected and beneficial effects may increase as the amount of calcium carbonate increases (e.g., increases to 70 wt % or more, based on the total weight of the layer). For example, while not limited by any particular mechanism or theory, it is believed that calcium carbonate particles at least partially surrounded by a relatively small amount of polyvinyl alcohol provide exceptional strength and rigidity. According to embodiments of the disclosure, the calcium carbonate provides compressive resistance to the layer while the layer retains the strain resistance of polyvinyl alcohol.

The layer of the present disclosure is not limited to being a single layer. For example, embodiments of the present disclosure may also include a multilayer including a plurality of layers including calcium carbonate and/or a plurality of layers including polyvinyl alcohol and calcium carbonate. The plurality of layers may physically or directly contact one or more of each other, or may have additional elements or features therebetween.

In one or more embodiments, a multilayer includes the layer including the polyvinyl alcohol and calcium carbonate, and a protective layer on one or more sides of the layer including the polyvinyl alcohol and calcium carbonate. In one or more embodiments, the layer including the polyvinyl alcohol and calcium carbonate may be used as a layer or coating on paper or paperboard. Including the layer including the polyvinyl alcohol and calcium carbonate on paper or paperboard provides more rigidity to the paper or paperboard than a layer that includes only polyvinyl alcohol. The multilayer may include any suitable layer used in the art, and in some embodiments may include a layer including polyethylene. For example, the multilayer may include the layer including the polyvinyl alcohol and calcium carbonate, or the layer including polyvinyl alcohol and calcium carbonate, and a protective layer on a first side of the layer including the polyvinyl alcohol and calcium carbonate or the layer including polyvinyl alcohol and calcium carbonate, a second side of the layer including the polyvinyl alcohol and calcium carbonate or the layer including polyvinyl alcohol and calcium carbonate, or both. In embodiments of a container or straw including the layer including the polyvinyl alcohol and calcium carbonate, the first side may be an interior side and the second side may be an exterior side. The protective layer may protect the layer including the polyvinyl alcohol and calcium carbonate from oxidants (e.g., oxygen), moisture (e.g., water or water vapor), and/or acids, and/or the protective layer may prevent contents of a container including the layer including the polyvinyl alcohol and calcium carbonate from physically contacting a polymer of the layer (e.g., polyvinyl alcohol). The protective layer may include any suitable materials. For example, the protective layer may include a metallized film such as, for example, an aluminized film, and/or the protective layer may include a plasma layer.

In some embodiments, a condensed plasma layer having a thickness of 5 to 500 nanometers is applied to the PVOH/CaCO₃ film, creating a novel packaging material. The condensed plasma layer has several functions including, for example, as a barrier to degradation of the PVOH/CaCO₃ compound and as a sacrificial layer that can be eliminated under specific conditions to initiate the degradation of the compound. In this embodiment, the condensed plasma coating is an Aluminum Oxide or a Silicone Dioxide layer that can be etched or degraded by a strong base such as NaOH. In another embodiment, the condensed plasma coating serves to fulfill current existing government regulation prohibiting packaging with polymer to contact tobacco or related type materials. Therefore, embodiments of the disclosure including the condensed plasma coating contemplate a less environmentally harmful packaging with similar or better properties.

Deposition of a condensed plasma layer on to the film may be performed by physical vapor deposition using an electron beam emitter to heat the Aluminum Oxide or Silicone Dioxide and to create a vapor plasma cloud of molecules. This process may be performed in a contained area, under vacuum or atmospheric conditions, where a film is passed through the contained area. The plasma molecules travel to the surface of the film and condenses in a uniform (e.g., substantially uniform) and very thin layer of approximately 5 to 500 nanometers. The thin layer of the condensed plasma layer is enough to impart certain properties to the substrate/film including barrier to Oxygen, Moisture, and/or certain UV radiation

In one or more embodiments, the aluminized film may be thinner than those used in existing layers. For example, the aluminized film of one or more embodiments of the present application may be include 0.125 wt % of the aluminum used in existing aluminized films. In one or more embodiments, the protective layer includes an oxide such as, for example, a metal oxide (e.g., aluminum oxide, Al₂O₃). When embodiments of the layer including a protective layer are dissolved, the calcium carbonate and the components of the protective layer (e.g., metal) may be separated from the polyvinyl alcohol, and thus, the metal may be recoverable and/or recyclable as well.

The layer according to embodiments of the disclosure may also include any suitable additives or other components. For example, embodiments of the layer may include an additive such as, for example, cellulose and/or proteins (e.g., industrial proteins) to increase the strength and/or rigidity of the layer. Due to their visco-elastic properties, the proteins may have the ability to add toughness and tensile strength to the polyvinyl alcohol, or may be used alone. When proteins are included in the layer, care may be taken to ensure that the processing temperatures of the layer do not exceed the denaturation temperatures of the proteins. In some embodiments, the layer may include 25 to 30 wt % protein, 0.1 to 5 wt % polyvinyl alcohol and 70 to 90 wt % of calcium carbonate.

Embodiments of the present disclosure may be used to form a variety of products such as, for example, transparencies (e.g., for vehicles and/or electronic devices), containers, wrappers, straws, films, cups, plates, product pouches (e.g., tobacco pouches), cutlery, rigid packaging, and/or the like, but the present disclosure is not limited thereto. The container may have a body that defines an internal cavity capable of holding an article (e.g., a solid, liquid, and/or gas). The body of the container may include or be formed from the layer including the polyvinyl alcohol and calcium carbonate. Any of the products disclosed herein may be flexible or rigid, or may have a portion that is flexible and/or a portion that is rigid. In some embodiments, the wrapper may be a food wrapper such as, for example, a sandwich wrapper (e.g., a hamburger and/or cheeseburger wrapper), a hotdog wrapper, and/or the like. In some embodiments, the container may include a sealed bag (e.g., a bag that contains or will contain chips, popcorn, and/or the like), an unsealed bag (e.g., a grocery bag) a wrapper (e.g., a wrapper that contains or will contain a snack bar, health bar, and/or the like), a blister pack (e.g., a blister pack that contains or will contain a medicament and/or the like), a pouch, a confectionary package (e.g., a package that contains or will contain candy, ice cream, and/or the like), a cereal bag (e.g., a bag that that contains or will contain a cereal product and/or the like), a dairy product container, a bottle (e.g., a bottle to contain a carbonated beverage such as, for example, beer and/or the like), a box (e.g., a box that contains or will contain beer, wine, juice, soup, and/or the like), a can, a bread bag (e.g., a bag that contains or will contain bread), a bagel bag (e.g., a bag that contains or will contain bagels), containers that contains or will contain agricultural products, balloons, and/or the like, but the present disclosure is not limited thereto. In some embodiments, the layer including the polyvinyl alcohol and calcium carbonate may be used to form a tobacco pouch in which the tobacco does not physically contact the polyvinyl alcohol of the layer due to the presence of a protective layer.

According to embodiments of the present disclosure, the layer including the polyvinyl alcohol and calcium carbonate may be formed according to any suitable process. For example, embodiments of the disclosure may be formed using a high stalk or pocket bubble blown film extrusion process for making micro-voided, paper-like film. Rigid embodiments of the layer may be formed by any suitable process such as, for example, thermoforming, injection molding, profile extrusion, blow molding, and/or the like. For example, the layer including polyvinyl alcohol and calcium carbonate may be molded, for example, to form pesticide bottles, irrigation tubes, and/or the like, or the layer including polyvinyl alcohol and calcium carbonate may be thermoformed, for example, to form seedling trays, nursery pot trays, and/or the like.

Embodiments of the present disclosure will now be described in more detail with respect to prophetic examples. The prophetic examples are merely provided to illustrate embodiments of the disclosure, and the present disclosure is not limited thereto.

Prophetic examples of the layer may be formed to include calcium carbonate in amounts of 51 wt %, 54.5 wt %, and 65 wt %, respectively, based on the total weight of the respective layer. According to prophetic examples, a portion of the polyvinyl alcohol may be substituted with a starch (e.g., a thermoplastic potato starch (TPS) such as, for example, Bioplast 300, available from BIOTEC GmbH, Rhein, Germany). The polyvinyl alcohol may be cross-linked according to any suitable process such as, for example, thermal cross-linking, microwave cross-linking, ultrasound cross-linking, citric acid cross-linking (e.g., cross-linking utilizing citric acid as a cross-linking agent, sodium borate cross-linking (e.g., cross-linking utilizing sodium borate (borax) as a cross-linking agent), and/or the like. Thus, according to embodiments of the present disclosure, the cross-linking changes the physical properties of the resultant layer without (or substantially without) reducing the biodegradability of the layer (e.g., the cross-linking may be sufficiently low that it does not (or substantially does not) interfere with biodegradability of the resultant layer). Although cross-linking processes that subject the polyvinyl alcohol to high temperatures may denature the polyvinyl alcohol, a re-bonding of the denatured components may occur in the presence of calcium carbonate, thereby rendering resultant packaging more resistant to hydrolytic breakdown. According to prophetic examples citric acid may be added as a cross-linking agent to stabilize the polyvinyl alcohol and provide enhanced mechanical properties and adhesion to calcium carbonate. The compounding strands of the prophetic examples may be cool air dried, pelletized and stored in foil bags to avoid or reduce moisture absorption.

According to the prophetic examples, the compound and the polyvinyl alcohol source may be extruded utilizing a Haake horizontal sheet extruder and cooling roll haul off system. Any suitable cooling process such as, for example, air cooling, belt conveyor cooling, and/or the like. The product may be produced in the form of strips equal to the thickness and width of existing polypropylene straw dimensions. Compounding conditions of the prophetic examples are shown in Table 1 below.

TABLE 1

| | Compound Formula, wt % | | | | |
|---|---|---|---|---|---|
| | | | | | Plasticizer |
| | Polyvinyl | | Calcium | | (H₂O, ethylene |
| Prophetic | alcohol - | | Carbonate | Crosslinking | glycol, and |
| Example | Aquapak | TPS | (CaCO₃) | agent | glycerol) |
| 1 | 45 | 0 | 55 | 0 | 0 |
| 2 | 28 | 17 | 55 | 0 | 0 |
| 3 | 35 | 0 | 55 | 10 | 0 |
| 4 | 33 | 0 | 55 | 0 | 12 |
| 5 | 25 | 0 | 55 | 10 | 10 |

The compounder starting temperature setpoints and rates for Prophetic Examples 1 to 5 are shown below in Table 2.

TABLE 2

| | |
|---|---|
| Zone number 1 | 235° C. +/− 5° C. (230 to 240° C.) |
| Zone numbers 2 through 11 | 220° C. +/− 5° C. (215 to 225° C.) |
| Zone number 12 | 210° C. +/− 5° C. (205 to 215° C.) |
| Extruder speed | 50 pounds per hour (pph) |
| | (0.006 kilogram per second) |
| Extruder rotations per minute | 350 |
| (max) | |
| Feeder (speeds) | Based on material ratios by condition |
| Feeder rotations per minute | 300 |
| (max) | |

### Haake Sheet Extrusion Process Parameters

All compounding conditions and polyvinyl alcohol (either or both polyvinyl alcohols shown in Table 1) will be extruded into strips of 0.75 inch (19.05 mm) at 8.00 to 8.50 mil (0.203 to 0.216 mm) thick according to the parameters shown below in Table 3.

TABLE 3

| | |
|---|---|
| Extrusion temperatures | −220° C./−220° C./200° C./200° C. |
| Expected melt temperature | −195° C. |
| Chiller temperature | 20° C. |
| Haul-off distance from die | 9 inches (22.86 cm), running at max speed |

### Material and Sample Storage

Samples of both polymer sources, compound pellets, and strips will be collected and packaged in foil moisture barrier bags for analyses. The compound will be collected and stored in foil moisture bags until ready for extrusion. In one or more embodiments, desiccation may be performed prior to compounding.

### Stability

Strips prepared according to the above-described Haake sheet extrusion process were stored for 8 weights at ambient conditions. The strips were created by feeding the compound into the feed throat of the extruder, where the material was melted and plasticized under pressure and exited the horizontal die head to a 3 roller stack chiller system and forms and S-wrap. The film was the drawn down to desired width and thickness and optimized through speed of the nip rollers.

### Strip Preparation

The Haake was pre-heated and allowed to heat soak for 1 hour. Pellets were charged into the Haake hopper. After charging the hopper, the screw started rotating to a set rpm. The compound became molten as it traveled downstream to the die exit. Molten material exited the horizontal die forming a strip under pressure. The strip was then guided into the cooling rolls forming an “S” wrap. Cooled material was unwound from the cooling rolls and was draw down to the nip rollers. The nip roller speed was adjusted to draw down the strip to a desired thickness and width.

After 8 weeks, a significant difference in stiffness was observed for the non-treated strips that included 40% CaCO₃ relative to the treated strips that included 40% CaCO₃.

### Testing Method

The ASTM D-882 method was followed to measure the Secant Modulus 1% (strip stiffness): crosshead speed 0.200 inch/min, 500 N load cell. The strip thickness and width was measured and entered into the program. After mounting the strip between two grips with a 5 inch gauge length, the crosshead speed was initiated and the stress/strain curve was generated. The Secant Modulus 1% value was calculated and recorded. The stiffness of the non-treated strips that included 40% CaCO₃ after 8 weeks at ambient conditions was 57% of the initial stiffness, while the stiffness of the treated strips that included 40% CaCO₃ after 8 weeks at ambient conditions was 81% of the initial stiffness. After 8 weeks at ambient conditions, treated strips that included 55% CaCO₃ exhibited no loss in stiffness. The above-described strips were prepared with a goal of producing strips that mimic commercial straws opened, (e.g., 1.0 inch width and 8.5 mil thickness). As the level (or amount) of CaCO₃ increased, the process stabilized and the strips were more consistent, allowing the widest strip width at 55% CaCO₃.

TABLE 4
PVOH Haake Stability Test

| Condition | 2 | 2 | 5 | 5 | 7 | 7 |
|---|---|---|---|---|---|---|
| Week from extrusion | 0 | 8 ambient | 0 | 8 ambient | 0 | 8 ambient |
| CaCO3 | untreated | untreated | treated | treated | treated | treated |
| CaCO3% | 40 | 40 | 40 | 40 | 55 | 55 |
| Strip width, inches | 0.667 (1.69 | 0.667 (1.69 | 0.750 (1.91 | 0.750 (1.91 | 0.870 (2.21 | 0.870 (2.21 |
| | cm) | cm) | cm) | cm) | cm) | cm) |
| Strip thickness, mil | 22.0 (0.559 | 24.5 (0.662 | 23.6 (0.599 | 25.9 (0.658 | 26.5 (0.673 | 26.5 (0.673 |
| | mm) | mm) | mm) | mm) | mm) | mm) |
| MD Secant Modulus | 60,700 (418.51 | 34,531 (238.08 | 63,550 (438.15 | 51,689 (356.38 | 51,261 (353.43 | 53,660 (369.97 |
| 1%, psi | MPa) | MPa) | MPa) | MPa) | MPa) | MPa) |

| | | | |
|---|---|---|---|
| % Modulus (strip | 57 | 81 | 105 |
| stiffness) remaining | | | |
| after 8 weeks in | | | |
| ambient conditions | | | |

As used herein, the term “layer” may be used interchangeably with the term “film” and these terms may be assigned the same or substantially the same meaning. Additionally, it will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

Spatially relative terms, such as “beneath,” “below,” “lower,” “under,” “above,” “upper,” and the like, may be used herein for ease of explanation to describe one element or feature's relationship to another element(s) or feature(s). It will be understood that the spatially relative terms are intended to encompass different orientations of the device in use or in operation, in addition to the orientation described. For example, if the device is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” and “including,” when used in this specification, specify the presence of the stated features, integers, acts, operations, elements, and/or components, but do not preclude the presence or addition of one or more other features, integers, acts, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the terms “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively. Also, the term “exemplary” is intended to refer to an example or illustration.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

While the subject matter of the present disclosure has been described in connection with certain embodiments, it is to be understood that the subject matter of the present disclosure is not limited to the disclosed embodiments, but, on the contrary, the present disclosure is intended to cover various modifications and equivalent arrangements included within the spirit and scope of the appended claims, and equivalents thereof.

What is claimed is:

1. A layer comprising:
polyvinyl alcohol; and
20 wt % or more calcium carbonate, based on the total weight of the layer.

2. The layer of claim 1, wherein the calcium carbonate comprises stearic acid treated or untreated calcium carbonate.

3. The layer of claim 1, wherein the polyvinyl alcohol is cross-linked.

4. The layer of claim 1, wherein the layer comprises the calcium carbonate in an amount of 50 wt % to 97 wt %, based on the total weight of the layer.

5. The layer of claim 1, wherein the layer comprises the calcium carbonate in an amount of 70 wt % to 97 wt %, based on the total weight of the layer.

6. The layer of claim 1, further comprising a protective layer on a side of the layer that protects the layer including the polyvinyl alcohol and calcium carbonate from oxidants, moisture, and/or acids, and/or may protect the layer including the polyvinyl alcohol and calcium carbonate from physically contacting contents of a container including the layer including the polyvinyl alcohol and calcium carbonate.

7. The layer of claim 6, wherein the protective layer comprises a plasma coating.

8. The layer of claim 1, wherein the layer is thermally stable at temperatures up to 150° C.

9. The layer of claim 1, wherein the layer further comprises a protein.

10. A container comprising:
a body that defines an internal cavity capable of holding an article,
wherein the body comprises a layer comprising:
polyvinyl alcohol; and
20 wt % or more of calcium carbonate, based on the total weight of the layer.

11. The container of claim 10, wherein the calcium carbonate comprises stearic acid treated calcium carbonate.

12. The container of claim 11, wherein the polyvinyl alcohol is cross-linked.

13. The container of claim 10, wherein the layer comprises the calcium carbonate in an amount of 50 wt % to 97 wt %, based on the total weight of the layer.

14. The container of claim 10, wherein the layer comprises the calcium carbonate in an amount of 70 wt % to 97 wt %, based on the total weight of the layer.

15. The container of claim 10, further comprising a protective layer on a side of the layer that protects the layer including the polyvinyl alcohol and calcium carbonate from oxidants, moisture, and/or acids, and/or may protect the layer including the polyvinyl alcohol and calcium carbonate from physically contacting contents of the container.

16. The container of claim 15, wherein the protective layer comprises a plasma coating.

17. The container of claim 10, wherein the layer is thermally stable at temperatures up to 150° C.

18. The container of claim 10, wherein the layer further comprises a protein.

19. A container comprising:
a layer comprising:
polyvinyl alcohol; and
calcium carbonate.

20. The container of claim 19, wherein the layer comprises the calcium carbonate in an amount of 50 wt % to 97 wt %, based on the total weight of the layer.

21. The container of claim 19, further comprising a protective layer on a side of the layer that protects the layer including the polyvinyl alcohol and calcium carbonate from oxidants, moisture, and/or acids, and/or may protect the layer including the polyvinyl alcohol and calcium carbonate from physically contacting contents of a container including the layer including the polyvinyl alcohol and calcium carbonate.

22. The container of claim 21, wherein the protective layer comprises a plasma coating.

23. The container of claim 21, wherein the layer is thermally stable at temperatures up to 150° C.

24. The container of claim 21, wherein the layer further comprises a protein.
